(19) United States
(12) Patent Application Publication
(10) Pub. No.: US 2019/0367743 A1
(43) Pub. Date: Dec. 5, 2019

(54) MATERIALS AND METHODS FOR CORROSION INHIBITION OF ATOMICALLY THIN MATERIALS

(71) Applicant: Massachusetts Institute of Technology, Cambridge, MA (US)

(72) Inventors: Ju Li, Weston, MA (US); Zongyou Yin, Canberra (AU); Cong Su, Belmont, MA (US)

(73) Assignee: Massachusetts Institute of Technology, Cambridge, MA (US)

(21) Appl. No.: 16/484,986

(22) PCT Filed: Mar. 29, 2018
(86) PCT No.: PCT/US2018/025174

§ 371 Date: Aug. 9, 2019

Related U.S. Application Data
(60) Provisional application No. 62/478,259, filed on Mar. 29, 2017.

(51) Int. Cl. C09D 5/08; C09K 15/18; C01B 25/00; C01G 41/00; C01G 35/00; C01B 19/04

(52) U.S. Cl. CPC C09D 5/086; C09K 15/18; C01B 19/04; C01G 41/00; C01G 35/00; C01B 25/006

(57) ABSTRACT

Methods and materials for providing corrosion protection for atomically thin materials are described. In some embodiments, an atomically thin material may have a coating that includes one or more alkyl amine species. The coating may cover at least a portion of the atomically thin material, and the coating may form a corrosion protection layer. Depending on the particular materials, a coating may be ionically bonded to at least a portion of an atomically thin material. In some embodiments, a method of forming a corrosion protection layer on at least a portion of an atomically thin material may involve exposing at least a portion of an atomically thin material that corrodes under normal atmospheric conditions to an alkyl amine.

### CROSS-REFERENCE TO RELATED APPLICATIONS

This application is a national stage filing under 35 U.S.C. § 371 of International patent application serial number PCT/US2018/025174, filed Mar. 29, 2018, which claims the benefit under 35 U.S.C. § 119(e) of U.S. provisional application Ser. No. 62/478,259, filed Mar. 29, 2017, the disclosure of each of which is incorporated by reference in its entirety.

### GOVERNMENT SUPPORT

This invention was made with Government support under Grant No. DMR-1120901 awarded by the National Science Foundation (NSF). The Government has certain rights in the invention.

### FIELD

Embodiments related to materials and methods for corrosion inhibition of atomically thin materials are disclosed.

### BACKGROUND

Atomically thin materials continue to be developed and integrated into different applications. For example, due to the band gaps present and various types of atomically thin materials, applications at these materials are used for include, but are not limited to various optoelectronic applications such as optical detectors, light emitting diodes, photovoltaics, as well as other appropriate applications outside of optoelectronics. However, certain atomically thin materials are susceptible to corrosion from water, oxygen, and other materials present under normal ambient atmospheric conditions which has limited their real-world application.

### SUMMARY

In one embodiment, a material includes an atomically thin material that corrodes under normal atmospheric conditions and a coating comprising an alkyl amine covering at least a portion of the atomically thin material. The alkyl amine coating forms a corrosion protection layer.

In another embodiment, a material includes an atomically thin material and a coating comprising an alkyl amine ionically bonded to at least a portion of the atomically thin material.

In yet another embodiment, a method of forming a corrosion protection layer on an atomically thin material that corrodes under normal atmospheric conditions includes: exposing at least a portion of the atomically thin material to an alkyl amine; and forming the coating on the at least a portion of the atomically thin material with the alkyl amine.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a schematic of a cross-section view of a material including an atomically thin material and a coating, according to some illustrative embodiments;

FIG. 1B is a schematic of a cross-section view of a material including an atomically thin material disposed on a substrate and covered with a coating, according to some illustrative embodiments;

FIG. 2A is a schematic of a cross-section view of a material including an atomically thin material ionically bound to an alkyl amine, according to some illustrative embodiments;

FIG. 2B is a schematic of a cross-sectional view of a material including a self-assembled monolayer of alkyl amines ionically bound to an atomically thin material, according to some illustrative embodiments;

FIG. 3A is a schematic of a cross-section view of a material including an alkyl amine bound to an atomically thin material, according to some illustrative embodiments;

FIG. 3B is a schematic top view of the material of FIG. 3A;

FIG. 4 is a flowchart illustrating methods of forming a corrosion protection layer on at least a portion of an atomically thin material, according to some illustrative embodiments;

FIG. 5 shows optical microscopy images for coated and uncoated samples taken before and after corrosion exposure for some atomically thin materials, including black phosphorus (BP) and tungsten disulfide (WS₂);

FIG. 6 shows a comparison of Raman spectra at λ=532 nm for coated and uncoated black phosphorous flakes during aging under ambient conditions;

FIG. 7 is a schematic diagram depicting proton transfer during a coating process of atomically thin black phosphorus with n-hexylamine and the resulting n-hexylamine monolayer formed on black phosphorus;

FIG. 8 shows a calculated energy profile of water and oxygen molecules when penetrating through a hexamine monolayer coating black phosphorus; and

FIGS. 9A-9B presents AFM data on a reversible process of n-hexylamine coating on black phosphorus (BP) and tungsten diselenide (WSe₂) respectively.

### DETAILED DESCRIPTION

The Inventors have recognized the problem of some atomically thin materials having limited applicability due to air-sensitivity or vulnerability to corrosion under normal atmospheric conditions. Specifically, some atomically thin materials may corrode due to the presence of water and/or oxygen during exposure to normal atmospheric conditions at normal temperature and pressure, which may also be referred to herein as air. For example, the surfaces of the atomically thin material interact with the water and/or oxygen from the surrounding environment leading to corrosion of the material according to various corrosion mechanisms. As noted above, this corrosion may limit the application of these materials regardless of their desirable operational properties. Accordingly, the Inventors have recognized that if corrosion prone atomically thin materials were to be protected from the surrounding environment, the may be employed in various applications where their desirable properties may lead to improved device performance.

In view of the above, the Inventors have recognized the benefits associated with forming a corrosion protection layer on at least a portion of, and in some instances substantially all, of the exposed surfaces of an atomically thin material that corrodes under normal atmospheric conditions. Specifically, the coating may comprise one or more species of alkyl amines bonded to one or more surfaces of the atomically thin material.

The Inventors have recognized that coating including one or more alkyl amine species with large enough coverage densities on a corresponding portion of an atomically thin material may exclude, or at least hinder, water (H₂O) and oxygen (O₂) penetration through the coating. Thus, the coating may reduce, and in some instances prevent, corrosion of the underlying portion of the atomically thin material. Accordingly, in some embodiments, a coating including the one or more alkyl means species may have a percent coverage that is at least 50%, 60%, 66.7%, 70%, 80%, 90%, or any other appropriate coverage percentage. As elaborated on in the examples below, coatings with percent coverages greater than 66.7% of a maximum theoretical coverage may be sufficient to exclude water and oxygen and coverages greater than 50% of a maximum theoretical coverage may be sufficient to exclude at least water. The above-noted percent coverages may be at most 100% of a maximum theoretical coverage which may be determined using either molecule size and/or modeling to estimate this parameter. Combinations of the above referenced ranges are possible (e.g., coverage between or equal to 50% and 100%). Of course while particular ranges are noted above, ranges including coverages less than those noted above are also contemplated as the disclosure is not so limited.

The above noted coatings may be formed in any desired manner. However, in one embodiment, a relative simple method for forming a corrosion protection layer on at least a portion of the exposed surfaces of an atomically thin material may involve exposing the atomically thin material to at least one species of alkyl amine. This method may involve exposing the atomically thin material to a solution containing one or more alkyl amine species, e.g., by immersing at least a portion, or substantially all of the exposed surfaces, of the atomically thin material in the solution. In some embodiments, the solution may be maintained at a temperature between the melting temperature and the boiling temperature of the one or more alkyl amines. Alternatively, in instances where the solution includes components other than the one or more alkyl amine species, the solution may be maintained at a temperature between the melting and boiling temperatures of the solution.

Without wishing to be bound by theory, the inclusion of different alkyl amine species within a corrosion protection layer may provide a coating with fewer defects due to the smaller alkyl amine molecules filling gaps located in portions of the coating formed by larger uncle amine molecules. Thus, in some embodiments, a coating formed on an atomically thin material may include a plurality of species of alkyl amines including, for example, a coating with at least 2, 3, 4, or any other suitable number of different species of alkyl amines. Further, a solution in which an atomically thin material may be at least partially merged to form a coating may include a plurality of alkyl amine species including, for example, 2, 3, 4, or any other appropriate number of alkyl amine species as the disclosure is not so limited.

In some embodiments it may be desirable to remove at least a portion of an alkyl amine coating formed on an atomically thin material. In such an embodiment, the coating formed by the alkyl amine may be removed by exposing at least a portion of the coated material to an acid. In some instances, the acid may be an organic acid such as acetic acid, or a mixture of hydrochloric acid and ethanol. Further, while the coatings may be removed with certain acids, the coatings may exhibit a bond with the atomically thin materials that is strong enough to withstand exposure to various organic solvents including, for example, acetone, ethanol, isopropanol, hexane, and/or other appropriate solvents. Consequently, the coatings may be formed and solutions including these solvents and/or cleaned using these solvents while still being capable of being removed when exposed to an appropriate acid.

The coatings and solutions described herein may include alkyl amines including alkyl groups with any appropriate number of carbons. However, in some embodiments, the coatings and/or solutions described herein may include one or more alkyl amines having an alkyl group between or equal to 4 and 11 carbons in length. In such an embodiment, the alkyl amine may have the chemical formula CₙH₂ₙ₊₃N, wherein n is between or equal to 4 and 11. Thus, the one or more alkyl amines may include one or more of butylamine, pentylamine, hexylamine, heptylamine, octylamine, nonylamine, decylamine, and undecylamine. Without wishing to be bound by theory, formation of the desired corrosion protection coatings may be simplified by using these particular alkyl amines due these materials being in liquid form under normal operating conditions (e.g., at normal temperature and pressure). In contrast, alkyl amines having an alkyl group of fewer than 4 carbons may be in gas form at normal temperature and pressure, and alkyl amines having an alkyl group of greater than 11 carbons in length may be in solid form at normal temperature and pressure, making such coating methods more challenging. “Normal temperature and pressure” herein refers to atmospheric conditions of 20 (twenty) degrees Celsius and 1 (one) atmosphere.

While particular alkyl amines including alkyl groups with a particular number of carbons are described above, embodiments in which coatings and/or solutions including alkyl amines with alkyl groups having a number of carbons both greater than less than those noted above (i.e. n less than 4 and greater than 11) are also contemplated. For example, the operating temperatures and/or pressures for coating formation may be altered to ensure the alkyl amines are in a liquid phase during the coating process.

Without wishing to be bound by theory, the Inventors have recognized that coatings including branched alkyl amines may exhibit reduced coverage and/or corrosion protection. as compared to an unbranched alkyl group of the same length. Specifically, a bulky branched alkyl group may disturb an interaction, such as an ionic bond or a hydrogen bond, between the nitrogen moiety of the branched alkyl amine and an atomically thin material that the branched alkyl amine is covering. This bulky branched alkyl group may create a competing mechanism (e.g., Van der Waals forces) of interaction between the non-linear alkyl amine and the atomically thin material. Accordingly, this competing mechanism may contribute to a lower percent coverage of molecules (e.g., alkyl amines) on the atomically thin material, resulting in a less protective coating, relative to a similar coating having a linear alkyl amine.

In view of the above, the Inventors have recognized that a coating that includes an unbranched alkyl amine may have a larger percent coverage of molecules (e.g., up to 100% coverage) on a surface of an atomically thin material. Again without wishing to be bound by theory, the use of unbranched alkyl amines may provide increased corrosion protection as compared to a coating that includes a branched alkyl amine. Thus, in some embodiments, the solutions and or coatings disclosed herein may use one or more alkyl amines that are unbranched alkyl amines. However, embodiments in which one or more branched alkyl amines are used are also contemplated as the disclosure is not so limited.

As used herein, an “unbranched alkyl amine” refers to an alkyl amine having an alkyl moiety that is an unbranched alkyl group. A “branched alkyl amine” herein refers to an alkyl amine having an alkyl moiety that is a branched alkyl group.

In some embodiments, the alkyl amine coatings may be in the form of a monolayer disposed on at least a portion of the atomically thin material. A “monolayer” herein refers to a layer that is one molecule in thickness (e.g., a diameter, width, thickness, length, or other appropriate dimension of a molecule depending on its orientation relative to the underlying material). In some embodiments, a monolayer of alkyl amines on an atomically thin material may have a thickness between or equal to 1 nm and 2 nm.

In order to utilize the intrinsic properties of the native atomically thin material exposed to ambient environments, it may be advantageous to have the total atomically thin material thickness greater than two times the passivation layer thickness. The functional properties of atomically thin materials (e.g., atomically thin crystals) may be extremely sensitive to the crystal thickness down to a layer a single atom in thickness. Therefore, corrosion control down to the level of a few molecular layers or a single molecular layer may be practically useful. Therefore, depending on the particular atomically thin material and the one or more alkyl amine species used form and associated coating, the atomically thin material may have a thickness that is greater than two times a thickness of the corresponding coating. However, embodiments in which coating thicknesses both greater and smaller than that noted above are also contemplated.

In some embodiments, the above noted monolayer may be a self-assembled monolayer that may spontaneously form on the one or more exposed portions of an atomically thin material upon exposure (e.g., by immersion) to a liquid or gas comprising one or more alkyl amines for coating the atomically thin material. Further, due to the bonding mechanism, a single molecular layer of alkyl amines may prevent further layers from being deposited on top of the single molecular layer in a self-limiting mechanism helping to facilitate the deposition of a self-assembled monolayer.

While embodiments are described above in which the coatings are monolayer coatings, embodiments in which coatings with thicknesses greater than a single molecular layer are deposited are also contemplated.

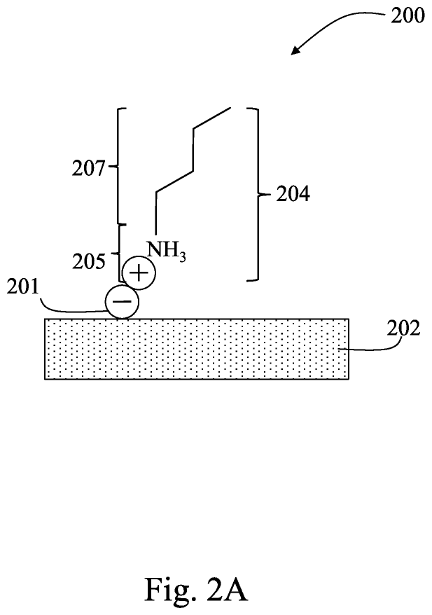

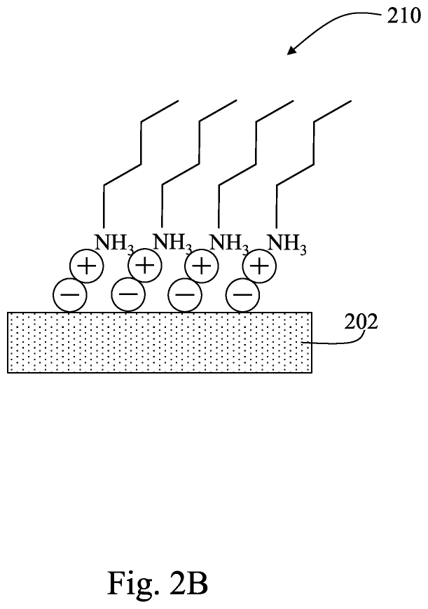

In some embodiments in which an alkyl amine interacts with an atomically thin material by an ionic bond, the alkyl amine may have a proximal-distal orientation, relative to the plane of the atomically thin material, in which the amine moiety of the alkyl amine is proximal to the surface of the atomically thin material and the alkyl moiety of the alkyl amine is distal to the surface of the atomically thin material (see, e.g., FIG. 2A). In some embodiments, an alkyl amine in this proximal-distal orientation may have an alkyl moiety that is a linear alkyl group between or equal to 4 and 10 carbons in length. In some embodiments, a coating comprising alkyl amines in a proximal-distal orientation may comprise a self-assembled monolayer (SAM) of alkyl amines in the proximal-distal orientation (see, e.g., FIG. 2B).

In some embodiments, a freestanding atomically thin material may be coated with the above described alkyl amine coatings. However, in some embodiments, an atomically thin material may be disposed upon a substrate or other supporting structure that helps to support and/or provide a desired functionality for the atomically thin material. In such an embodiment, one or more surfaces of the atomically thin material may be disposed against the substrate such that they are not exposed to the exterior environment. Accordingly, corrosion protection coatings may not be formed on these unexposed portions of the atomically thin material. Instead, the disclosed coatings may be formed on one or more portions, or substantially all, of the exposed surfaces of the atomically thin material.

It should be understood that a substrate on which an atomically thin material is disposed may comprise any suitable material. Suitable substrate materials may include, but are not limited to, semiconductors (e.g. silicon, germanium, gallium arsenide, gallium nitride, and other appropriate semiconductors), insulators (e.g. silicon dioxide), porous semiconductor on insulator structures, metals (e.g. metallic or metalized electrical contacts), polymers (e.g. PMMA or PDMS), and/or any other appropriate substrate as the disclosure is not so limited.

In some embodiments, the above described coatings may provide protection against corrosion for the associated portion, or entirety, of an atomically thin material for a duration of least one day, 2 days, 5 days, 10 days, 15 days, 20 days, 30 days, 40 days, 50 days, 100 days, 150 days; at most 190 days, at most 200 days; (e.g., between or equal to 1 day and 200 days) and/or any other appropriate time period as the disclosure is not so limited. The continued presence of an alkyl amine coating, and thus, the corresponding duration of protection, may be measured, e.g., by Raman spectroscopy, optical microscopy, or photoluminescence spectroscopy, or another suitable method capable of detecting the continued presence of the coatings on a particular atomically thin material. In some embodiments, an uncoated atomically thin material may entirely corrode within about 2 days when exposed to normal atmospheric conditions.

Atomically thin materials that are vulnerable to corrosion under normal atmospheric conditions may include, but are not limited to, atomically thin black phosphorus, silicene, stanene, and transition metal dichalcogenides. A transition metal dichalcogenide may include a transition metal and a chalcogenide and may have the chemical formula MX₂, where M is at least one of molybdenum (Mo), tungsten (W), and tantalum (Ta) and X is at least one of sulfur (S), selenium (Se), and Tellurium (Te). Non-limiting examples of transition metal dichalcogenides include tungsten disulfide (WS₂), tungsten diselenide (WSe₂), molybdenum diselenide (MoSe₂), molybdenum ditelluride (1T′-MoTe₂), tungsten ditelluride (WTe₂), tantalum disulfide (TaS₂), and niobium diselenide (NbSe₂).

With regards to the above materials, atomically thin black phosphorus (BP) may have a favorable bandgap for detecting infrared, which may therefore make atomically thin BP a good candidate for a component of a photodetector. In addition, the intrinsic charge carrier mobility of atomically thin black phosphorus may also be high, and therefore atomically thin black phosphorus may be useful for making other electronic devices. Different atomically thin transition metal dichalcogenides may exhibit different band gaps and may be used in photovoltaics and other electronic devices, e.g. optoelectronic devices, where various band gaps may be desirable.

While the current disclosure is primarily directed to atomically thin materials that prone to corrosion under normal atmospheric conditions, embodiments in which a coating is formed on a more stable atomically thin material also contemplated. For example, atomically thin materials that are inherently more stable against corrosion (also referred to herein as corrosion-stable atomically thin materials) may include but are not limited to graphene and atomically thin hexagonal boron nitride (HBN) (e.g., single-layer HBN). These atomically thin materials may also be coated with molecules that are used in a corrosion protection layer for atomically thin materials that are vulnerable to corrosion. However, in some embodiments, the means by which the molecules interact with a corrosion-stable atomically thin material may differ from how the molecules interact with the disclosed atomically thin materials that are prone to corrosion.

Depending on the particular atomically thin material and corresponding one or more alkyl amines used for the coating, the alkyl amine molecules may be bonded to the underlying atomically thin material in different ways. For example, in some embodiments, the alkyl amine molecules may be ionically bonded to at least a portion of the atomically thin material. In other embodiments, the alkyl amine molecules may be bonded to at least a portion of the atomically thin material by Van der Waals forces or hydrogen bonding. These concepts are elaborated on further below.

The Inventors have recognized that in some embodiments an alkyl amine molecule may bond with an atomically thin material by an ionic bond, in which a Coulombic interaction holds the molecule to the atomically thin material. In some such embodiments, an alkyl amine may be ionically bound to an atomically thin material. In some embodiments, a nitrogen of the alkyl amine may be positively charged and ionically bound to a negatively charged oxygen or other negatively charged moiety on a surface of the atomically thin material. In some embodiments, the negatively charged oxygen on the surface of the atomically thin material, and/or the positively charged nitrogen of the alkyl amine, may result from a proton transfer from a hydroxyl group on the surface of the atomically thin material to the amine moiety of the alkyl amine. Sources of hydroxyl groups on atomically thin materials (e.g., such as black phosphorus) may include but are not limited to water from handling the atomically thin material under normal atmospheric conditions, water present in a solution in which at least a portion of the atomically thin material is immersed (e.g., during formation of a coating on the atomically thin material), and/or any other appropriate source and/or method capable of forming the desired hydroxyl groups on the atomically thin material. Without wishing to be bound by theory, the above noted ionic bond may result in the alkyl amine molecules being oriented such that the carbon chains of the alkyl moiety extend away from the underlying surface of the atomically thin material. This may enable the deposition of denser alkyl amine coatings. Again, without wishing to be bound by theory, it is believed that alkyl amines including an unbranched alkyl group between or equal to 4 and 10 carbons in length may be bonded to an atomically thin layer and arranged in the above noted orientation. In some embodiments, a molecule may interact with an atomically thin material by hydrogen bonding.

The Inventors have recognized that in some embodiments an alkyl amine molecule may bond with an atomically thin material by Van der Waals forces. Specifically, in some embodiments, an alkyl moiety of the alkyl amine may be bound to a surface of an atomically thin material by Van der Waals forces. In some embodiments, the Van der Waals forces binding a molecule to the atomically thin material may be strong enough, and the percent coverage of the molecules on the surface of the atomically thin material may be sufficiently large, such that a corrosion protection layer may still be formed by the resulting coating of alkyl amine molecules. As elaborated on further below, alkyl amine molecules bonded to an atomically thin material using Van der Waals forces may be oriented in a direction that is approximately parallel to a corresponding surface of the atomically thin material the molecule is disposed on. Without wishing to be bound by theory, in some embodiments, an alkyl amine bonded to an atomically thin material in this orientation parallel to the underlying surface via Van der Waals forces may result when an alkyl moiety of the alkyl amine includes a linear alkyl group between or equal to 11 and 12 carbons in length.

Turning again to a method of forming a coating, and atomically thin material may be formed by exfoliating a starting material (e.g., black phosphorus having multiple layers) to form the atomically thin material (e.g., atomically thin black phosphorus, single-layer black phosphorus). Exfoliation may be carried out in inert atmosphere so as to prevent corrosion of the atomically thin material resulting from exfoliation. However, embodiments in which a preformed atomically thin material is simply obtained without performing an exfoliation step are also contemplated. In some embodiments, the resulting exfoliated atomically thin material (e.g., atomically thin BP) may spontaneously develop a layer of hydroxyl groups on its surface spontaneously (e.g., from a small amount of water vapor in an inert atmosphere, or water present in a liquid solution in which at least a portion of the atomically thin material is subsequently immersed). In either case, the atomically thin material may then be at least partially immersed in a solution containing one or more alkyl amine species. The solution may be contained in any appropriate container including, for example, a vial, a beaker, a closed chamber, or any other appropriate container capable of containing the solution and atomically thin material. As described previously, in some embodiments, the alkyl amine species may react with hydroxyl groups located on the surface of the atomically thin material to bond the resulting alkyl amine coating to the atomically thin material. The presence of hydroxyl groups on a surface of an atomically thin material may be determined using any appropriate detection method. In some embodiments, the hydroxyl groups may be detected using methods including, but not limited to, x-ray photoelectron spectroscopy (XPS) where a shift may be detected for the amine moieties of alkyl amines coating the atomically thin material. This shift in the expected XPS spectrum may indicate the presence of a hydrogen atom from the hydroxyl groups.

Depending on the particular embodiment, a solution used to form an alkyl amine coating on an atomically thin material may include any appropriate amount of an alkyl amine. For example, a solution may comprise a volume percentage of alkyl amines that is at least 0.3%, 1%, 3%, 10%, 20%, 30%, 40%, 50%, 60%, 70%, 80%, 90%, 97%, 99%, or any other appropriate volume percentage.

In some embodiments, the solution used for an alkyl amine coating on an atomically thin material may include one or more organic solvents. Appropriate organic solvents may include, but are not limited to, acetone, ethanol, isopropyl, hexane, combinations of the foregoing, and/or any other appropriate solvents that do not substantially react with the resulting coating and/or inhibit its formation. The above-noted solvents may be present in any appropriate volume percentage including, for example, a volume percent that is greater than or equal to 1%, 5%, 10%, 20%, 30%, 50%, or any other appropriate volume percentage. Correspondingly, the solvents may be present in a volume percentage that is less than or equal to 99%, 95%, 90%, 80%, 70%, 60%, and/or any other appropriate volume percentage. Combinations of the foregoing ranges are contemplated including, for example, a solution including a volume percentage of solvent that is between or equal to 1% and 99%, 50% and 90%, and/or any other appropriate combination.

In addition to the one or more alkyl amines, in some embodiments, the above-noted solutions may include some amount of water. Specifically, a solution in which an atomically thin material is immersed in may include a volume percentage of water that is less than or equal to 10 volume percent, 5 volume percent, 3 volume percent, 1 volume percent, 0.3 volume percent and/or any other appropriate volume percentage of water as the disclosure is not so limited. In some embodiments, as the volume percent water in the solution decreases, the occurrence of corrosion side reactions may correspondingly decrease during coating formation. This may result in both improved operating parameters of the atomically thin material as well as improved quality of the resulting corrosion protection coating. Accordingly, in at least one embodiment, a water content of the solution may be made to be as low as possible such that it is at least less than or equal to 10 volume percent water. However, embodiments in which solutions contain volume percentages of water greater than those noted above are also contemplated.

It should be understood that the above-noted solutions may include combinations of the foregoing volume percentages of alkyl amines, organic solvents, and/or water. However, embodiments in which an alkyl amine solution is used to form a coating without appreciable amounts of organic solvents and/or water in the solution are also contemplated.

To facilitate formation of a coating on an atomically thin material at least partially immersed in a solution, it may be desirable to maintain the solution in a liquid state. Accordingly, in some embodiments, a temperature of a solution during a coating formation process may be maintained between a melting temperature and a boiling temperature of the solution. Further, in order to help reduce a vapor pressure of the alkyl amines and/or precipitation of the alkyl amines from solution, in some embodiments, it may be desirable to maintain the temperature of the solution between a melting temperature and a boiling temperature of the alkyl amine itself. In some embodiments, the solution may be disposed in a sealed pressurized container such that a boiling temperature of the solution may be increased relative to the boiling temperature when exposed to normal atmospheric conditions with a pressure of about 1 atm.

In addition to maintaining a solution in the desired liquid state, a temperature of the solution may also be controlled to either improve the kinetics of coating the atomically thin material and/or the quality of the resulting coating. Further, in some embodiments, a solution temperature that is closer to the boiling temperature than to the melting temperature of the solution may result in faster coating and/or increased quality of the resulting coating relative to coatings formed at lower solution temperatures closer to the melting temperature of the solution.

In regards to the above noted temperature ranges: n-butylamine has a boiling point of approximately 78° C.; n-hexylamine has a boiling point of 131.5° C.; n-octylamine has a boiling point of approximately 176° C.; and n-decylamine has a boiling point of approximately 217° C. Further, these materials typically are liquids at temperatures of about 25° C.

In view of the above, it should be understood that a temperature of a solution may be maintained between any appropriate range of temperatures depending on the particular materials included in the solution. However, in one embodiment, a temperature of the solution may be maintained between or equal to 25° C. and 300° C. for a time duration between or equal to 1 minute and 60 minutes. In some embodiments, the time duration may be between or equal to 10 minutes and 30 minutes (e.g., 20 minutes).

While particular ranges of temperatures and durations are noted above, it should be understood that the solution temperature and coating duration may be greater or less than the ranges indicated above. Instead, it should be understood that any number of different temperatures may be maintained for an appropriate duration to form a coating with a desired percent coverage as the disclosure is not limited to any particular combination of operating parameters.

After an initial portion of coating formation in a solution maintained at the above noted elevated temperatures, the solution may be maintained at a second lower temperature for a predetermined duration. For example, in some embodiments, a solution may be cooled from a first elevated temperature to a second lower temperature. This second lower temperature may be approximately room temperature in certain embodiments, and may correspond to a temperature between or equal to about 15° C. and 25° C. This lower temperature of the solution may be maintained for any appropriate duration including durations between or equal to 10 minutes and 24 hours (e.g., between or equal to 3 hours and 24 hours, between or equal to 3 hours and 4 hours). However, embodiments in which the second lower temperature is either greater than or lower than the temperature ranges noted above and/or the second lower temperature is maintained for shorter and/or longer durations than the duration ranges noted above are also contemplated as the disclosure is not so limited.

In some instances, it may be desirable to remove contaminants and/or excess coating solution from an atomically thin material after it has been coated. In such an embodiment, the coated atomically thin material may be washed using an appropriate organic solvent which may include acetone, ethanol, isopropanol, hexane, and/or other appropriate solvents. After washing, the coated atomically thin material may be dried. Drying may be provided using any appropriate method including, but not limited to, blowing nitrogen (N₂) gas across the material under normal atmospheric conditions.

To help improve coating quality, in certain embodiments, it may be desirable to anneal a coated atomically thin material. Specifically, and without wishing to be bound by theory, annealing may promote surface mobility of alkyl amine molecules disposed on a surface of the atomically thin material. For example, before annealing, there may be one or more areas with a higher concentration of coating molecules and one or more areas with a lower concentration of coating molecules. This may result in the low concentration area(s) being vulnerable to corrosion. However, the molecules may redistribute during annealing to form a more uniform coating with more evenly spaced alkyl amine molecules. Thus, annealing may reduce the presence of defects in the coating and may create a more continuous corrosion protection coating. This may be especially beneficial in embodiments including lower coverage percentages of a surface of the atomically thin material (e.g. coverage percentages between or equal to about 50% and 70%, 66.7% and 80%, and/or any other appropriate coverage percentage). However, it should be understood that annealing may be beneficial for coatings including any coverage percentage including coverage percentages that are both greater and less than those noted above.

During an annealing process, an atomically thin material may be annealed in an atmosphere such as argon, nitrogen, hydrogen, or vacuum. Further, appropriate annealing temperatures applied to the coated atomically thin material may be between or equal to 100 degrees Celsius and 300 degrees Celsius for between or equal to 10 minutes and 50 minutes (e.g., between or equal to 150° C. and 250° C. for between or equal to 20 minutes and 40 minutes; e.g., at 200 degrees Celsius for 30 minutes).

In one non-limiting illustrative embodiment of a method for forming a coating of alkyl amines on atomically thin black phosphorus, the method may include exfoliating black phosphorus in a glovebox (having an inert atmosphere, e.g., comprising nitrogen and/or argon) to form atomically thin black phosphorus. The resulting exfoliated atomically thin black phosphorus may readily develop a layer of hydroxyl groups on its surface spontaneously (e.g., from the small amount of water in the glovebox atmosphere or in a liquid in which at least a portion of the atomically thin black phosphorus is immersed). The illustrative method proceeds with immersing at least a portion of the atomically thin black phosphorus in a liquid solution having 97 volume percent alkyl amine and 3 volume percent water, directly following exfoliation. The illustrative method proceeds with maintaining a temperature of the solution at a temperature greater than or equal to the melting temperature of the alkyl amine and less than or equal to the boiling temperature of the alkyl amine (e.g., within 70° C., within 60° C., within 50° C., within 40° C., within 30° C., within 20° C., or within 10° C., of the boiling temperature of the alkyl amine) for between or equal to 15 minutes and 25 minutes (e.g., 20 minutes). The illustrative method is followed by cooling the solution to approximately room temperature.

As used herein, “normal temperature and pressure” and other similar terms may refer to a temperature of about 20° C. and a pressure of about 1 atmosphere. Correspondingly, as used herein, “normal atmospheric conditions” and other similar terms may refer to ambient atmospheric conditions at a temperature of about 20° C. and a pressure of about 1 atmosphere where both oxygen and water vapor are included in the ambient atmosphere.

A “corrosion protection layer” as used herein may refer to a layer that functions as a barrier (e.g., a physical and/or chemical barrier) against water, oxygen, and other corrosive substances in an environment surrounding an atomically thin material.

As used herein, an “atomically thin material” will be understood by those of ordinary skill in the art to refer to a material that is made up of one or more layers of an atomically thin material. Atomically thin materials typically have strong chemical bonds within a plane or layer, but have relatively weaker bonds out of the plane with neighboring planes or layers. Therefore, atomically thin materials typically form sheets of material that may be a single atom thick, i.e. monolayer sheets, or thicker sheets that include several adjacent planes of atoms. For example, an atomically thin material may be considered to be a sheet or layer of material including one or more adjacent crystal planes extending parallel to a face of the sheet or layer. An atomically thin material may have a thickness corresponding to any appropriate number of crystal planes including sheets with a thickness corresponding to 1 atomic layer, or in some instances, a thickness that is less than or equal to 2, 3, 4, 5, or 10 atomic layers, or any other appropriate number of atomic layers. Further, depending on the particular type of atomically thin layer and/or material being used, the atomically thin material may have a thickness between 0.1 nm and 10 nm, or between 0.3 nm and 5 nm, or between 0.345 nm and 2 nm. However, ranges both larger and smaller than those noted above are also contemplated as the disclosure is not so limited. Atomically thin materials may also be referred to as ultra-strength materials and/or two-dimensional materials.

For the sake of clarity, embodiments and examples described herein are primarily directed to atomically thin black phosphorus and atomically thin transition metal dichalcogenides. However, the methods and materials described herein are not so limited. For example, other appropriate atomically thin materials that may be coated using the currently disclosed methods and materials may include, but are not limited to, hexagonal boron nitride, molybdenum sulfide, vanadium pentoxide, silicon, doped-graphene, graphene, graphene oxide, fluorinated graphene, covalent organic frameworks, layered transition metal dichalcogenides (comprising, e.g., MoS₂, TiS₂, NiO₂, etc.), layered Group-IV and Group-III metal chalcogenides (e.g., SnS, PbS, GeS, etc), silicene, germanene, and layered binary compounds of Group IV elements and Group III-V elements (e.g., SiC, GeC, SiGe), and any other appropriate atomically thin material.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

As detailed above, the coatings disclosed herein may include one or more alkyl amines. An alkyl amine may have an alkyl moiety (or alkyl portion) and an amine moiety (or amine portion).

As used herein, the term “alkyl” is given its ordinary meaning in the art and refers to the radical of saturated aliphatic groups, including straight-chain alkyl groups (also referred to herein as unbranched alkyl groups), branched-chain alkyl groups (also referred to herein as branched alkyl groups), cycloalkyl (alicyclic) groups, alkyl substituted cycloalkyl groups, and cycloalkyl substituted alkyl groups. In some cases, the alkyl group may be a lower alkyl group, i.e., an alkyl group having between or equal to 1 and 10 carbon atoms (e.g., methyl, ethyl, propyl, butyl, pentyl, hexyl, heptyl, octyl, nonyl, or decyl). In some embodiments, a branched or unbranched alkyl may have 30 or fewer carbon atoms in its backbone, and, in some cases, 20 or fewer. In some embodiments, a branched or unbranched alkyl may have 12 or fewer carbon atoms in its backbone (e.g., C₁-C₁₂ for straight-chain, C₃-C₁₂ for branched-chain), 6 or fewer, or 4 or fewer. Likewise, cycloalkyls may have between or equal to 3 and 10 carbon atoms in their ring structure, or 5, 6 or 7 carbons in the ring structure. Thus, as used herein, the term “alkyl” includes unbranched, branched and cyclic alkyl groups. Furthermore, as used herein, the term “alkyl” encompasses both substituted and unsubstituted groups. Examples of alkyl groups include, but are not limited to, methyl, ethyl, propyl, isopropyl, cyclopropyl, butyl, isobutyl, t-butyl, cyclobutyl, hexyl, and cyclochexyl.

In certain embodiments, the alkyl groups employed in the disclosure contain between or equal to 1 and 20 aliphatic carbon atoms. However, as noted previously, in some embodiments, it may be advantageous for the alkyl groups described herein to contain between or equal to 4 and 11 aliphatic carbon atoms. However, in other embodiments, the alkyl groups employed in the disclosure may also contain between or equal to 1 and 3 or 12 and 20 aliphatic carbon atoms. Illustrative aliphatic groups thus include, but are not limited to, e.g., methyl, ethyl, n-propyl, isopropyl, allyl, n-butyl, sec-butyl, isobutyl, t-butyl, n-pentyl, sec-pentyl, isopentyl, t-pentyl, n-hexyl, sec-hexyl, moieties and the like, which again, may bear one or more substituents.

The term “amine,” as used herein, refers to a primary (—NH₂), secondary (—NHRₓ), tertiary (—NRₓR_{y}), or quaternary (—N⁺RₓR_{y}R_{z}) amine, where Rₓ, R_{y}, and R_{z} are independently an aliphatic, alicyclic, heteroaliphatic, heterocyclic, aryl, or heteroaryl moiety, as defined herein. Examples of amine groups include, but are not limited to, methylamine, dimethylamine, ethylamine, diethylamine, methylethylamine, iso-propylamine, piperidine, trimethylamine, and propylamine.

As used herein, the term “hydroxyl” or “hydroxy” refers to the group —OH.

It will be appreciated that the above groups and/or molecules, as described herein, may be optionally substituted with any number of substituents or functional moieties. That is, any of the above groups may be optionally substituted. As used herein, the term “substituted” is contemplated to include all permissible substituents of organic compounds, “permissible” being in the context of the chemical rules of valence known to those of ordinary skill in the art. In general, the term “substituted” whether preceded by the term “optionally” or not, and substituents contained in formulas of this disclosure, refer to the replacement of hydrogen radicals in a given structure with the radical of a specified substituent. When more than one position in any given structure may be substituted with more than one substituent selected from a specified group, the substituent may be either the same or different at every position. It will be understood that “substituted” also includes that the substitution results in a stable compound, e.g., which does not spontaneously undergo transformation such as by rearrangement, cyclization, elimination, etc. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl group” must still comprise the phenyl moiety and cannot be modified by substitution, in this definition, to become, e.g., a pyridine ring. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this disclosure, the heteroatoms such as nitrogen may have hydrogen substituents and/or any permissible substituents of organic compounds described herein which satisfy the valencies of the heteroatoms. Furthermore, this disclosure is not intended to be limited in any manner by the permissible substituents of organic compounds. The term “stable,” as used herein, preferably refers to compounds which possess stability sufficient to allow manufacture and which maintain the integrity of the compound for a sufficient period of time to be detected and preferably for a sufficient period of time to be useful for the purposes detailed herein.

Turning now to the figures, several non-limiting embodiments are described in further detail. However, it should be understood that the current disclosure is not limited to only those specific embodiments described herein. Instead, the various disclosed components, features, and methods may be arranged in any suitable combination as the disclosure is not so limited.

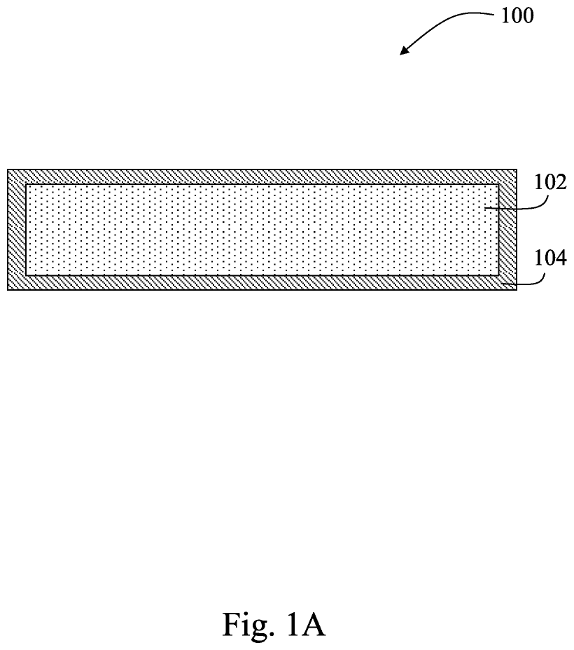

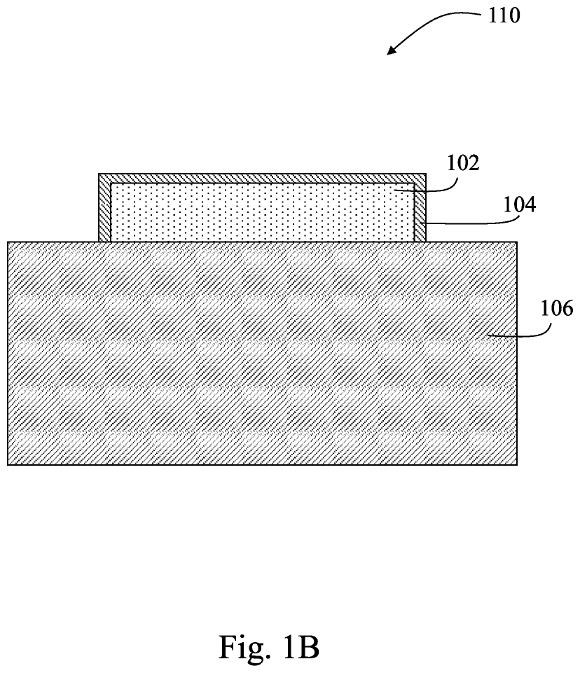

FIG. 1A is a schematic of a cross-section view of a material 100 including an atomically thin material 102 and a coating 104, according to some illustrative embodiments. The depicted schematic shows the coating 104 covering all surfaces of a free-standing atomically thin material 102.

FIG. 1B is a schematic of a cross-section view of a material 110 including an atomically thin material 102 disposed on a substrate 106 and covered with a coating 104, according to some illustrative embodiments. The depicted schematic shows the coating 104 covering all exposed surfaces of the atomically thin material 102. The surface of the atomically thin material oriented towards, and disposed on, the substrate is uncoated.

FIG. 2A is a schematic of a cross-section view of a material 200 including an alkyl amine 204 ionically bound to an atomically thin material 202. The alkyl amine 204 is oriented in a proximal-distal orientation relative to the plane of the atomically thin material such that the carbon chain of the alkyl group extends away from a surface or plane of the atomically thin material. Negatively charged ion 201 may be ionically bound to a positively charged ion 205 of the alkyl amine 204, so the amine group may be located proximal to the surface of the atomically thin material 202. Alkyl group 207 (depicted as n-butyl, an unbranched alkyl group) of the alkyl amine 204 may stand distal to the surface of the atomically thin material 202. In some embodiments, alkyl group 207 may be n-butyl, n-pentyl, n-hexyl, n-heptyl, n-octyl, n-nonyl, or n-decyl.

FIG. 2B is a schematic of a cross-section view of a material 210 including a self-assembled monolayer of alkyl amines bound to an atomically thin material 202. In the depicted embodiment, each alkyl amine is oriented in a proximal-distal orientation relative to the plane of the atomically thin material 202. In some embodiments, a respective alkyl group of each alkyl amine may be n-butyl, n-pentyl, n-hexyl, n-heptyl, n-octyl, n-nonyl, or n-decyl. In some embodiments, there is a combination of alkyl amines on the surface of atomically thin material 202, each having one of n-butyl, n-pentyl, n-hexyl, n-heptyl, n-octyl, n-nonyl, or n-decyl as its respective alkyl group.

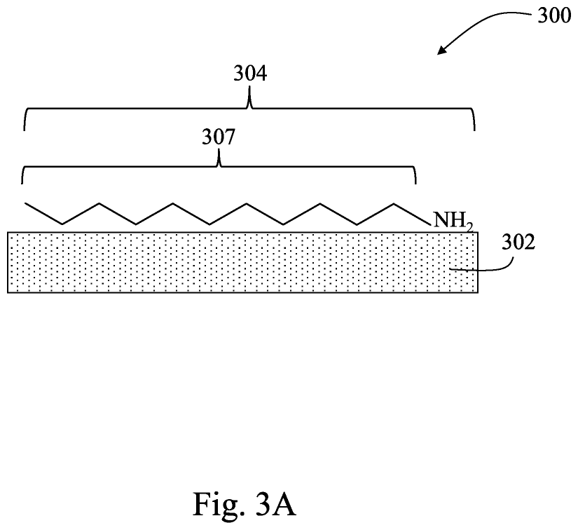

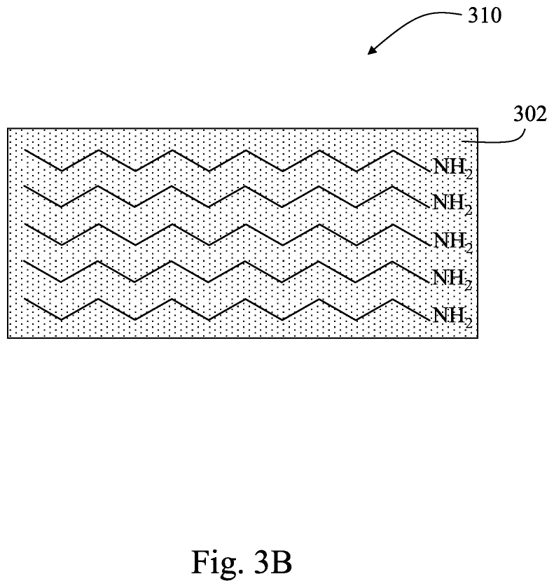

FIG. 3A is a schematic of a cross-section view of a material 300 including an alkyl amine 304 bound to an atomically thin material 302. The alkyl amine 304 is positioned in an orientation that is approximately parallel to a surface or plane of the atomically thin material. Alkyl group 307 may be bound to the surface of the atomically thin material 302 along the length of the alkyl group 307 by Van dar Waals forces. In some embodiments, alkyl group 307 may be n-undecyl or n-dodecyl.

FIG. 3B is a top view of the material 310 of FIG. 3A. Each alkyl amine molecule is again positioned in an orientation that is approximately parallel to a surface plane of the atomically thin material 302. As depicted in the figure, the molecules are arranged such that they form a self-assembled monolayer of the alkyl amines bound to the underlying atomically thin material 302.

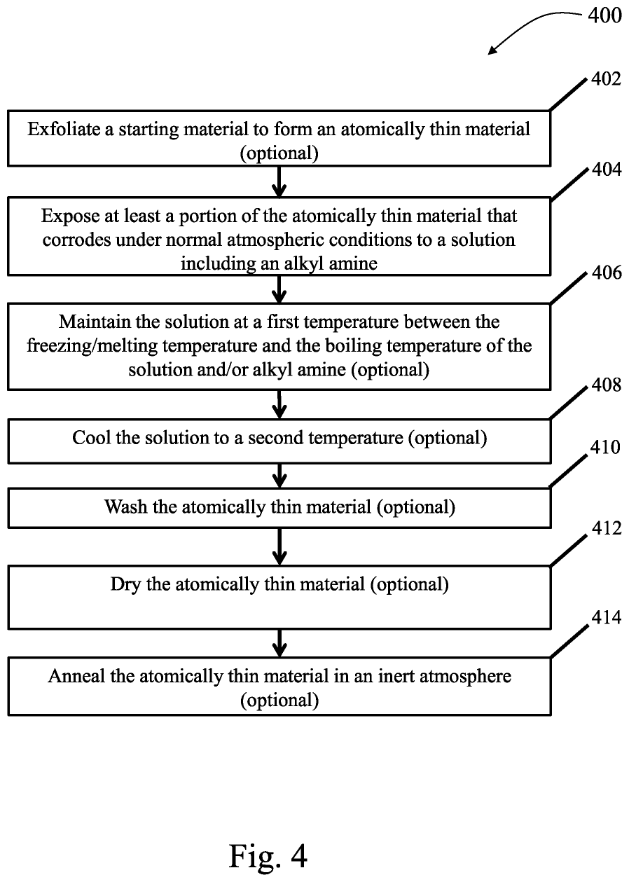

FIG. 4 is a flowchart illustrating an exemplary method 400 for forming a coating comprising an alkyl amine on at least a portion of an atomically thin material, according to some illustrative embodiments. As illustrated, at step 402, a starting material (e.g., black phosphorus, a transition metal dichalcogenide) may be exfoliated to form an atomically thin material. However, a preformed atomically thin material acquired without exfoliating it from a starting material may also be used. In either case, in some embodiments, the atomically thin material may be one that corrodes under normal atmospheric conditions. At step 404, at least a portion of the atomically thin material may be exposed to an alkyl amine (e.g., by immersing at least one portion, or substantially all, of the atomically thin material in a liquid solution comprising the alkyl amine). The atomically thin material may be exposed to either a single alkyl amine or a plurality of alkyl amines at step 404 (e.g., at least one of butyl, pentyl, hexyl, heptyl, octyl, nonyl, decyl, undecyl, dodecyl, or a combination thereof). At step 406, a temperature of the solution the atomically thin material is immersed in may be maintained at a temperature between a melting or freezing temperature and a boiling temperature of the solution and/or the alkyl amine. The temperature of the solution may affect both the speed of coating formation as well as the quality of the coating (e.g., the percent coverage of alkyl amines on the at least one portion of the atomically thin material, number of defects, etc.). For example, maintaining the solution at a higher temperature may result in shorter coating times and improved coating coverage. At step 408, the solution the atomically thin material is immersed in may be cooled to a second lower temperature. Depending on the particular embodiment, the second lower temperature may correspond approximately to room temperature. Formation of the coating may continue during step 408. At step 410, the atomically thin material may be washed with an appropriate organic solvent (e.g., with ethanol). At step 412, the atomically thin material may be dried (e.g., with nitrogen (N₂) gas blown over the surface under normal atmospheric conditions). At step 414, the atomically thin material may be annealed in an inert atmosphere to reduce the presence of defects in the coating and create a more continuous corrosion protection layer comprising the alkyl amine.

### Example: Comparisons with Alternative Passivation Strategies

Alternative passivation strategies for atomically thin materials may present issues related to processing and other drawbacks. For example, metal oxide coatings may be prone to cracking and may be less deformable than coatings comprising alkyl amines. As another example, polymers (e.g. poly(methyl methacrylate) (PMMA), polystyrene (PS), poly(p-xylylene), perylene-3,4,9,10-tetracarboxylic dianhydride (PTCDA)) may be readily attacked by organic solvents and may offer limited durability compared with coatings comprising alkyl amines. As another example, self-assembled monolayers (SAMs) with silane-terminated octadecyltrichlorosilane (OTS) may be very toxic, or may form too strong a bond with the surface of the atomically thin material being coated, compared with coatings comprising alkyl amines.

In contrast to the above, the currently disclosed coatings and methods present both a facile and scalable process for passivating a large variety of atomically thin materials that may greatly increase the lifetime of the these materials under ambient conditions or even under harsh chemical and thermal conditions. Further, these coatings were capable of being removed using particular acids to expose the underlying surface of the atomically thin material.

Molecular dynamics simulations suggest that the alkyl amine coatings repel H₂O but may be permeable to O₂, which may react with the atomically thin material to form an ultra-thin oxide passivation layer beneath the alkyl amine that grows very slowly. Normally soluble in water, this oxide layer may have been protected from dissolution by the hydrophobic alkyl amine molecule coating, which may have shut down subsequent oxidation/dissolution cycles of, leading to significantly slower corrosion and longevity for many different classes of atomically thin materials.

### Example: Corrosion of Coated and Uncoated Atomically Thin Materials

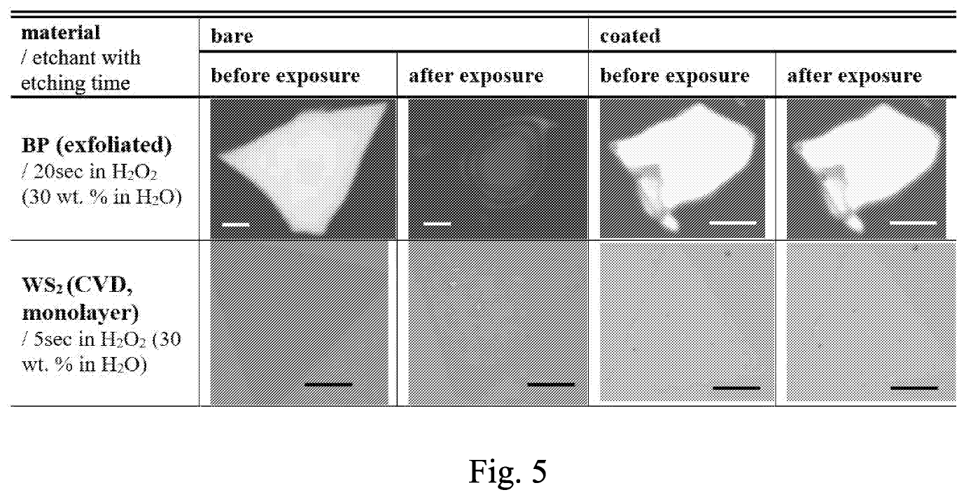

FIG. 5 shows optical microscopy images taken during corrosion exposure for some atomically thin materials, including black phosphorus (BP) and tungsten disulfide (WS₂), bare or coated with n-hexylamine, in accordance with certain illustrative embodiments. Other materials that were tested in both the coated and uncoated condition using n-hexylamine include 1T′-MoTe₂, WTe₂, WSe₂, TaS₂, and NbSe₂. These materials were dipped in etchants of H₂O₂ or KMnO₄ solution (depending on the respective material reactivity) as an accelerated lifetime test. The uncoated counterparts were processed in parallel with the coated parts under identical etching conditions. Scale bars represent 10 microns (μm). The etching conditions for the various materials were as follows: BP (exfoliated) for 20 sec in H₂O₂ (30 wt. % in H₂O); WΩ (CVD, monolayer) exposed for 5 sec in H₂O₂ (30 wt. % in H₂O); 1T′-MoTe₂ (exfoliated) for 10 sec in H₂O₂ (30 wt. % in H₂O); WTe₂ (exfoliated) exposed for 30 sec in H₂O₂ (30 wt. % in H₂O; WSe₂ (exfoliated) exposed for 1 min in KMnO₄ (0.02 mol/L in H₂O); TaS₂ (exfoliated) exposed for 1 min in KMnO₄ (0.01 mol/L in H₂O); and NbSe₂ (exfoliated) exposed for 20 sec in H₂O₂ (30 wt. % in H₂O). In all cases, the bear uncoated atomically thin materials were significantly changed after exposure, indicating corrosion, and the atomically thin materials coated with n-hexylamine did not change after exposure, indicating protection from corrosion by the n-hexylamine coating.

This drastic difference in appearance between uncoated/unprotected and coated/protected atomically thin materials after exposure to etchants confirms that the presently disclosed coatings provide robust protection for atomically thin materials.

### Example: Black Phosphorous

Since black phosphorous (BP) was highly vulnerable to corrosion among the atomically thin materials studied, it created the most problematic challenges for processing and applications. Therefore, it is used herein as an illustrative example of alkyl amine corrosion inhibitors. Once mechanically exfoliated, the BP flakes were highly reactive and chemically unstable. After keeping an approximately 3 nm-thick BP flake in ambient air for 2 days, only vague traces remained, even when care was taken to prevent light exposure, known to accelerate the damage. Optical images of an exfoliated approximately 3 nm-thick BP were taken on SiO₂/Si wafer before aging (on 0 day), and after 2-day aging in ambient conditions where only blurry marks of the original flake could be identified.

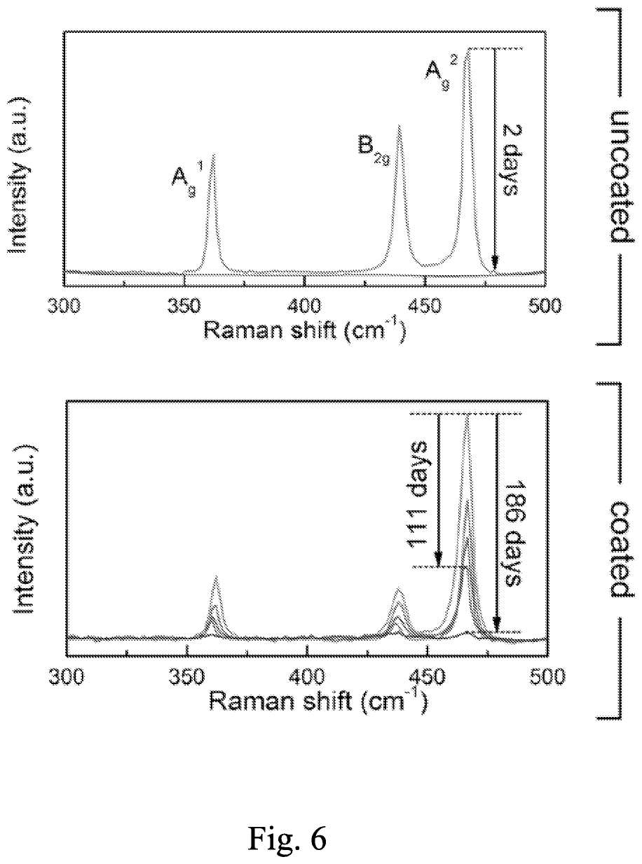

FIG. 6 shows a comparison of Raman spectra at λ=532 nm between few-nanometer-thick BP flakes without (top) and with (bottom) a coating of n-hexylamine during aging under ambient conditions, in accordance with certain illustrative embodiments. Three characteristic Raman peaks of BP at 361 cm⁻¹ (A_{g}¹), 438 cm⁻¹ (B_{2g}), and 466 cm⁻¹ (A_{g}²) completely disappeared after 2 days (e.g., FIG. 6, top), with Raman spectra at λ=532 nm for this sample. The degradation of BP was further expedited when exposed to light.

In contrast to the above, n-hexylamine coated BP (HA-BP) exhibited robust BP characteristics for a significantly extended period (e.g., FIG. 6, bottom). This was shown for a piece of n-hexylamine-coated BP (˜4 nm thick) on SiO₂/Si. As shown in the figure, the corresponding Raman spectra of the n-hexylamine-coated sample were still present when measured at 0, 13, 41, and 111 days confirming that the BP is still present. Further, the peaks are still somewhat present even in the last spectrum measured at 186 days. The difference in optical images for HA-BP between 0 day and 111 days aging under ambient conditions was essentially indiscernible except for a slight edge corrosion; 32% of the intensity of A_{g}² was retained after 111 days. The light flux from laser and lamp absorbed by HA-BP during Raman measurements in 111 days was equivalent to 1.0×10⁵ W/cm² for approximately 2 hours in total. Since this photon exposure was already substantial enough to cause the degradation of bare BP, the lifetime of HA-BP may be extended even further if the sample were not exposed to the strong laser. Samples were treated for 30 min at 120° C. in air right after preparation. Raman spectra have been renormalized and calibrated to Si (reference) peak intensity.

### Example: Coating Process

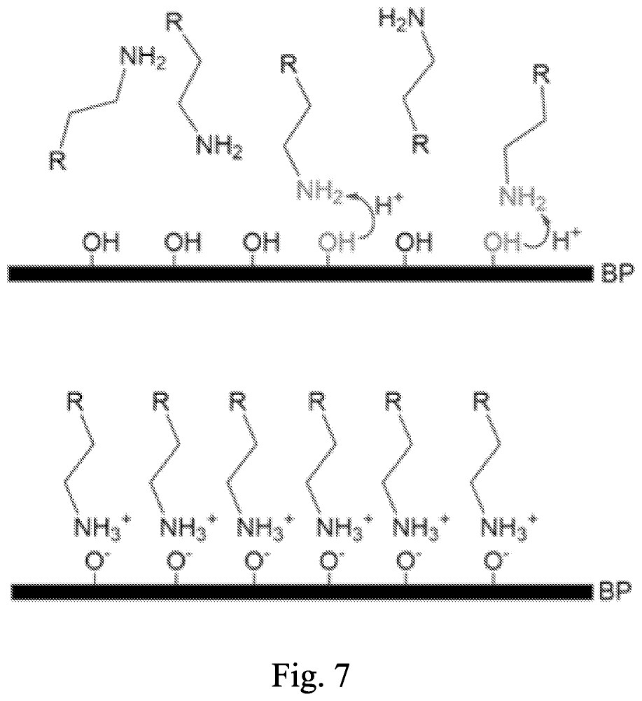

FIG. 7 is a schematic diagram depicting proton transfer during a coating process of atomically thin black phosphorus with n-hexylamine (top) and an n-hexylamine monolayer formed on black phosphorus by the coating process (bottom), according to some illustrative embodiments. The coating process may have involved first hydroxylation of BP and then proton transfer to the —NH₂ group of n-hexylamine. Molecular simulations suggested that n-hexylamine formed a molecular monolayer as shown in FIG. 7.

The top layer of the BP surface may have been rapidly oxidized, presumably forming P—OH, P—O⁻, or P═O surface groups. Experimental evidence supported a model where the acidic P—OH groups on the BP surface and the terminal —NH₂ groups of alkyl amines underwent a Brønsted-Lowry acid-base reaction to form a layer of alkyl ammonium salts that coated the BP surface through a strong electrostatic interaction with the deprotonated P—O⁻ surface sites. Support that the neutral —NH₂ group in n-hexylamine became charged (i.e. —NH₃⁺) came from X-ray photoelectron spectroscopy (XPS): comparing the N is peaks between HA-BP, dodecylamine (C₁₂H₂₅NH₂, R—NH₂), and methylammonium chloride (CH₃NH₃Cl, R—NH₃⁺) revealed that HA-BP and R—NH₃⁺ had the same binding energy, which was blue-shifted by 2.4 eV from that of R—NH₂. Protonation of the terminal amine groups in our coatings were therefore supported by this data.

Contact angle measurements also showed that the surface of BP became more hydrophobic after n-hexylamine (HA) coating, supporting that the HA coating was terminated by alkyl chains, not by amine/ammonium groups. Polar organic solvents including acetone, ethanol, or isopropanol, as well as non-polar solvents like hexane, could not remove the n-hexylamine coating, indicating that the interaction between n-hexylamine and BP was strong enough to sustain common solvent attack. In contrast, n-hexane did not impart any corrosion protection, supporting that the amine group was a factor in the corrosion protection and that the alkyl chain itself did not bind strongly on BP.

First-principles calculations were employed to investigate the transfer of protons when n-hexylamine approached P—OH, formed by reacting with the controlled quantity of water in the n-hexylamine coating solution. Among various structural possibilities, the most likely reaction pathway agreed with the scenario (P—O⁻—NH₃⁺—C₆H₁₃) proposed and yielded a bonding strength of 0.97 eV, which was 3-4 times stronger than the pure Van der Waals (VdW) force (approximately 0.33 eV between n-hexylamine and pure BP; approximately 0.22 eV between amines and graphene). The electronic density distribution showed that the H atom shared its orbital much more with the N atom than with the 0 atom, and a Bader's charge analysis indicated that n-hexylammonium (C₆H₁₃NH₃⁺) carried a net charge of +0.89e, and to compensate, the rest had −0.89e.

### Example: Water and Oxygen Exclusion

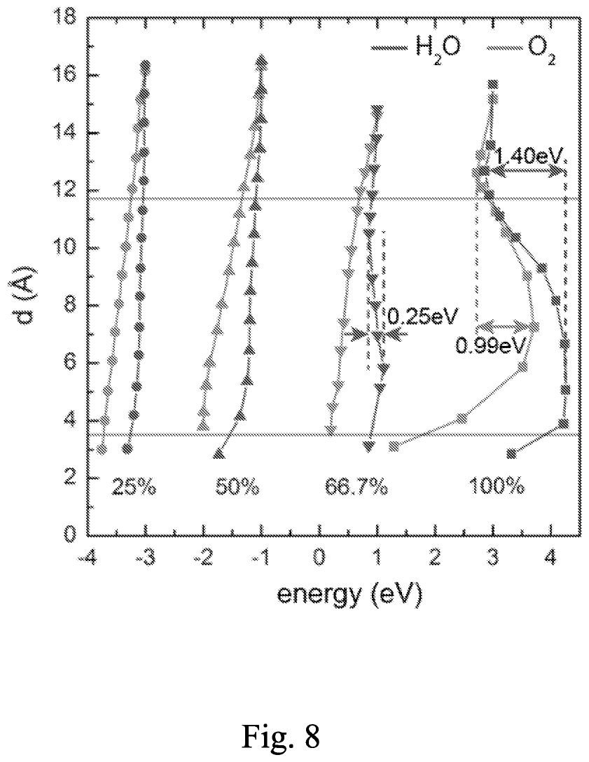

FIG. 8 shows an energy profile of water and oxygen molecules when penetrating through a hexamine monolayer coating black phosphorus, in accordance with some illustrative embodiments. The y-axis is the distance between the bottom atom of water or oxygen and the surface of black phosphorus, denoted as “d”. The four groups of curves represent different percent coverages of 25%, 50%, 66.7%, and 100%, as marked. The horizontal lines are the locations of the top and the bottom of hexylamine molecules.

The migration energy barrier Q of H₂O through n-hexylamine was calculated to be 1.4 eV and O₂ 1.0 eV, when n-hexylamine covered BP in the densest possible packed structure (herein 100% coverage); when the coverage dropped to 66.7%, the migration energy barrier reduced to 0.2 eV for H₂O and no barrier formed for O₂. When the HA coverage further decreased to 50% or 25%, the migration of both H₂O and O₂ through the HA layer towards the surface of BP was barrier-less (FIG. 8). Combining these theoretical analysis results and the time-evolution of XPS data on phosphorous oxide concentration, where the oxidization speed of phosphorous after n-hexylamine coating was significantly reduced by 32 times at the beginning of oxidation. This may indicated that the coverage of n-hexylamine on BP was more than 66.7% on the surface of BP.

### Example: Other Alkyl Amines

The anti-corrosion effect conferred by alkyl amines was not limited to n-hexylamine. Indeed, n-butylamine (n-C₄H₉NH₂), n-pentylamine (n-C₅H₁₁NH₂), n-octylamine (n-C₈H₁₇NH₂), n-decylamine (n-C₁₀H₂₁NH₂), and n-undecylamine (n-C₁₁H₂₃NH₂) all consistently displayed similar anti-corrosion effects. The growth parameters for coating some of these alkyl amines with different carbon chain lengths are summarized in Table 1 below, and their coatings onto BP were demonstrated to have anti-corrosion effects at least by optical microscopy and/or Raman spectroscopy and/or photoluminescence spectroscopy.

### Example: Removal of Coatings

Unlike the irreversible covalent bonding, e.g., created when protecting BP with aryl diazonium precursors, the non-covalent bonding (e.g., ionic bonding) between the HA and BP was strong but still reversible. The n-hexylamine was able to be completely removed by treating HA-BP with either glacial acetic acid or a mixture of acetone and aqueous HCl (37%). Without wishing to be bound by theory, the organic-media-supported protons may have penetrated the hydrophobic alkyl layer, protonated the ionized surface P—O⁻ groups, and disrupted their electrostatic interaction with the alkyl ammonium cations. The alkyl ammonium cations may then have been released, leaving BP unprotected. After treating HA-BP with glacial acetic acid, the newly de-protected HA-BP was again susceptible to etchant. Similar demonstration was also performed for transition metal dichalcogenide flakes.

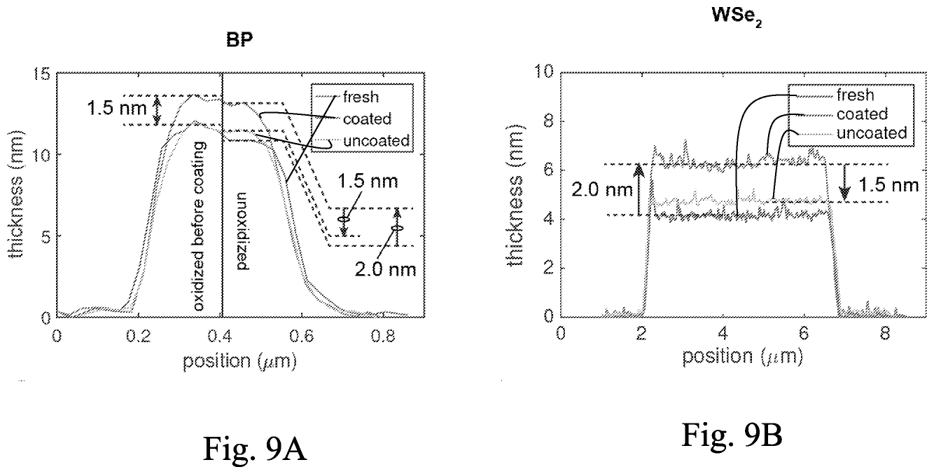

FIGS. 9A-9B present atomic force microscopy (AFM) data on a reversible process of n-hexylamine coating on black phosphorus (BP) and tungsten diselenide (WSe₂) respectively, in accordance with certain illustrative embodiments. AFM images were taken of the same BP flake at three stages: as-exfoliated (marked as “fresh”), after coating (marked as “coated”), and after removing the coating (marked as “uncoated”). In FIG. 9A, the AFM characterization of the thickness of the same BP flake during three stages is provided with the locations of height profile marked by solid lines (non-scale bars). The roughness was also measured at the same location for each sample after each step. The counterparts for WSe₂ are presented in FIG. 9B.

AFM data in FIG. 9A trace a coating process on BP by monitoring flake height and roughness. There were two different outcomes in different parts of the BP sample. First, on the left side of BP thickness profile plot, a coating layer with 1.5 nm thickness was completely removed after dipping into glacial acetic acid for 20 minutes. Second, on the right side, a coating layer with 2.0 nm thickness was first deposited, and 1.5 nm could be removed. On the other hand, in WSe₂ as presented in FIG. 9B, the tendency followed exactly the same with the second case in BP. One explanation could be as follows: the first case of BP indicated that BP may have already half oxidized before coating, so no change was observed for this part. The 0.5 nm thickness increase could be explained by the oxidation of the surface layer. For this part of BP and the whole WSe₂, no oxidation occurred before coating, so an extra 0.5 nm increase was homogeneous on the whole sample. Regardless of the pre-oxidation phase, both samples restored to their initial roughness and features after the un-coating process as confirmed with the AFM roughness measurement. Similar to stainless steel (SS), the first layer of the material (e.g., BP) may be turned into a passivation layer (PDX) protecting the rest of the materials; unlike SS, the passivation layers of BP and transition metal dichalcogenides may be stabilized by hexylamine coating, preventing hydrolysis. This reversible passivation coating is facile to make and unavailable from previous passivation methods of monolayer coatings. Aqueous solutions of strong acids have been tested to be not effective in this regard, which may be because the hydronium ion, H₃O⁺, cannot penetrate the hydrophobic alkyl layer: treating hexylamine coated samples with concentrated aqueous HCl did not remove n-hexylamine.

### Example: Photodetectors

Photodetectors were made with black phosphorus, respectively coated with hexylamine and uncoated, and etching test results for photocurrent and responsivity, in accordance with some illustrative embodiments. The assembled photodetectors including the uncoated and coated BP devices as well as the associated Ti/Au electrodes were subjected to etching in an aqueous solution of H₂O₂. Both devices exhibited almost the same shape of I-V-photon curve before etching. After dipping the devices in H₂O₂ for 5 seconds and drying them subsequently only with lab wipes (without washing with any solvent), obvious degradation was observed under optical microscope on the uncoated BP device, while little change was found on the coated device. Further, photocurrents were measured for the devices both pre and post etching as a function of input optical power under zero bias voltage. For the uncoated BP devices, both the photocurrent and the responsivity dropped to zero after etching. In contrast, the n-hexylamine-coated-devices still maintained ˜60% of the performance in terms of photocurrent and responsivity after etching. The drop of performance likely originated from defects in the coating layer within the boundaries between the electrode metal and the BP flake, and also likely originated from a residue of PMMA during the deposition of electrodes that blocked the growth of hexylamine. In either case, this confirms the efficacy of the disclosed coatings and methods in providing a coating capable of acting as a corrosion protection layer for an atomically thin material.

### Example: Coating of Hexylamine (C₆H₁₅N) onto BP

During testing, two dimensional (2D) black phosphorous (BP) crystals were mechanically exfoliated and transferred onto a silicon wafer (with a 190 nm silica (SiO₂) surface layer), denoted as 2D/SiO₂/Si, after SiO₂/Si substrates were annealed/dried in air for 30 min at 200° C. to remove absorbed water on the surface. All exfoliation was done in a nitrogen (N₂)-filled glove box. Hexylamine (Sigma-Aldrich, 99%) was degassed with the freeze-pump-thaw method for 3 cycles, dried by activated 4 Angstrom (A) molecular sieves for 3 days, and kept in a N₂-filled glove box. A subsequent coating of hexylamine was formed by a facile one-pot one-step process. 2D/SiO₂/Si samples were completely immersed in an excess amount of hexylamine in a vial, with a bit of water added. This vial was then covered with a cap and sealed with black carbon tape, and taken out from the glove box for heating (see, e.g., FIG. 4 for general steps followed). During heating, the glass vial was partially immersed in a Silicone oil bath and the temperature was maintained at about 130° C. with a growth time of about 20 min. At this stage, —OH groups may have formed on the 2D crystal surface; and hexylamine molecules may have bonded to the 2D crystal surface, e.g., through proton transferring from —OH to amine. The vial was then air-cooled for over 3 hours to complete the growth, 2D/SiO₂/Si samples were collected and gently washed with ethanol and dried immediately with N₂ gas blowing in air. Then, without any delay, the 2D flake samples were transferred into the glove box. Following this was a simple post-growth annealing, at 200° C. for 30 min, after sealing in a dried glass bottle in the glove box. Some defects in the hexylamine coating were expected to be annealed away during this step, creating a more continuous protection layer. Samples were then characterized and tested.

### Example: Coating of Hexylamine onto Relatively Stable WS₂, ReS₂

This coating was performed in a manner slightly different from above. Hexylamine was used as purchased for the growth. 2D flakes were first exfoliated and deposited onto SiO₂ (190 nm)/Si substrates, denoted as 2D/SiO₂/Si, in air. The subsequent coating of hexylamine was formed by one-step growth. In order to drive water and air out of hexylamine before the growth, hexylamine was boiled in a vial at about 130° C. for 30 min in air. Then, the 2D/SiO₂/Si samples were immediately immersed into boiling hexylamine carefully and the vial was covered with a cap but the cap was not tightened to avoid high pressure building in the bottle. After growth and subsequent cooling down, the samples were collected and gently washed with ethanol followed by immediate drying with N₂ gas blowing. A simple annealing was applied at 200° C. and 30 min in air and then the samples were ready for testing and characterization.

### Example: Coating Other Amines

Respective coatings of butylamine (C₄H₁₁N), hexylamine (C₆H₁₅N), octylamine (C₈H₁₉N), decylamine (C₁₀H₂₃N), undecylamine (C₁₁H₂₅N), benzylamine (C₆H₅CH₂NH₂), and hexane (C₆H₁₄, as control) were formed onto 2D BP with similar methods as presented above, except the growth temperatures, which were designed to be not higher or not much higher than the boiling point of each amine molecule (see, e.g., Table 1).

TABLE 1
Growth parameters list for amine molecules

| | C₄H₁₁N | C₆H₁₅N | C₈H₁₉N | C₁₀H₂₃N | C₆H₅CH₂NH₂ | C₆H₁₄ |
|---|---|---|---|---|---|---|
| Boiling point (° C.) | 78 | 131.5 | 176 | 217 | 185 | 68.7 |
| Growth | 90 | 130 | 140-160 | 150-180 | 180 | 80 |
| temperature (° C.) | | | | | | |

| | |
|---|---|
| Growth time | 20 min |
| Post-growth | 200° C. for 30 min in Argon |
| annealing | |

Beneficial growth parameters of hexylamine grown on BP were determined based at least in part on optical microscope images taken before and after oxidation of BP flakes. Pure fresh BP (not protected) was used as a control, which oxidized upon applying an oxidant. In one set of growth parameters, BP was immersed in hexylamine for 6 days at room temperature, which did not protect BP against oxidation. In another set of growth parameters, BP was immersed in hexylamine at 70° C. for 20 minutes, which did not protect BP against oxidation. In another set of growth parameters, BP was immersed in hexylamine at 90° C. for 20 minutes, which did not protect BP against oxidation. In yet another set of growth parameters, BP was exposed to hexylamine at 110° C. for 20 minutes, which did not protect BP against oxidation. In yet another set of growth parameters, BP was exposed to hexylamine at 130° C. for 20 minutes, resulting in partially protected BP against oxidation. Finally, BP was exposed to hexylamine at 130° C. for 20 minutes, followed by at 200° C. for 30 minutes in an argon environment during the whole exposure, resulting in a protected BP against oxidation.

### Example: Stability Testing

Stability testing was conducted with oxidants for amine-protected BP, where different growth temperatures were employed but each had a post-growth annealing. Optical microscope images were taken before and after oxidation of BP flakes. As a control, pure fresh BP was not given a treatment, and was oxidized upon applying an oxidant. Butylamine-coated BP with a treatment temperature of 90° C. was protected against oxidation. Pentylamine-coated BP with a treatment temperature of 110° C.; hexylamine-coated BP with a treatment temperature of 130° C.; decylamine-coated BP with a respective treatment temperature of 120° C., 150° C., and 180° C.; and undecylamine-coated BP with a treatment temperature of 180° C. were protected against oxidation. Hexane-coated BP with a treatment temperature of 90° C. was not protected against oxidation, nor was benzylamine-coated BP with a respective treatment temperature of 120° C., 150° C., and 180° C.

### Example: Coating Comparison

Table 2 shows a comparison of hexylamine coatings with alternative protection techniques. Factors such as coating thickness, resistive properties, and techniques used to form the coatings are compared.

TABLE 2
Comparison of hexylamine coatings with alternative protection techniques.

| | | | | Not | Advanced | Limitation of |
|---|---|---|---|---|---|---|
| Chemical | Thickness | | Resistant to | resistant to | Technique | Scalability |
| hexylamine | 1 | nm | Ambient air, | Acids | — | — |
| (amine family) | | | organic | | | |
| | | | solvent, H₂ | | | |
| | | | annealing | | | |
| AlOₓ | 2-30 | nm | Ambient air, | Acids, H₂ | Atomic layer | Limited by |
| | | | organic | annealing | deposition | vacuum |
| | | | solvent | | | chamber |
| PMMA | ~300 | nm | Ambient air | Organic | Spin coating | Limited by |
| | | | | solvent, H₂ | | spin coater |
| | | | | annealing | | |
| Graphene/hBN | ~4 | Å | Ambient air, | — | atomically | Limited by |
| | | | organic | | thin materials | graphene/hBN |
| | | | solvent, | | transfer | area and |
| | | | acids, H₂ | | method | transfer |
| | | | annealing | | | technique |
| poly(p- | 30-300 | nm | Ambient air | — | Thermal | Limited by |
| xylylene) | | | | | evaporation | vacuum |
| | | | | | | chamber and |
| | | | | | | furnace |

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A material comprising:
an atomically thin material that corrodes under normal atmospheric conditions; and
a coating comprising an alkyl amine covering at least a portion of the atomically thin material, wherein the alkyl amine coating forms a corrosion protection layer.

2. The material of claim 1, wherein the coating covers substantially all exposed surfaces of the atomically thin material.

3. The material of claim 1, wherein the alkyl amine has the chemical formula CₙH₂ₙ₊₁NH₂, wherein n is between or equal to 4 and 11.

4. The material of claim 1, wherein the alkyl amine comprises an alkyl group between or equal to 4 and 11 carbons in length.

5. The material of claim 4, wherein the alkyl group is unbranched.

6. The material of claim 1, wherein the alkyl amine comprises an unbranched alkyl amine.

7. The material of claim 1, wherein the alkyl amine comprises at least one of butylamine, pentylamine, hexylamine, heptylamine, octylamine, nonylamine, decylamine, or undecylamine.

8. The material of claim 1, wherein the coating is a monolayer.

9. The material of claim 1, wherein the atomically thin material comprises at least one of black phosphorus, a transition metal dichalcogenide, silicene, and stanene.

10. The material of claim 9, wherein the atomically thin material comprises black phosphorous.

11. The material of claim 9, wherein the atomically thin material comprises the transition metal dichalcogenide.

12. The material of claim 1, wherein the coating comprises molecules, and a percent coverage of the molecules on the at least one portion of the atomically thin material is at least 50% of a maximum coverage of the molecules on the atomically thin material.

13. A material comprising:
an atomically thin material; and
a coating comprising an alkyl amine ionically bonded to at least a portion of the atomically thin material.

14. The material of claim 13, wherein the coating covers substantially all exposed surfaces of the atomically thin material.

15. The material of claim 13, wherein the alkyl amine has the chemical formula CₙH₂ₙ₊₁NH₂, wherein n is between or equal to 4 and 11.

16. The material of claim 13, wherein the alkyl amine comprises an alkyl group between or equal to 4 and 11 carbons in length.

17. The material of claim 16, wherein the alkyl group is unbranched.

18. The material of claim 13, wherein the alkyl amine comprises an unbranched alkyl amine.

19. The material of claim 13, wherein the alkyl amine comprises at least one of butylamine, pentylamine, hexylamine, heptylamine, octylamine, nonylamine, decylamine, or undecylamine.

20. The material of claim 13, wherein the coating is a monolayer.

21. The material of claim 13, wherein the atomically thin material comprises at least one of black phosphorus, a transition metal dichalcogenide, silicene, and stanene.

22. The material of claim 21, wherein the atomically thin material comprises black phosphorous.

23. The material of claim 21, wherein the atomically thin material comprises the transition metal dichalcogenide.

24. The material of claim 13, wherein the coating comprises molecules, and a percent coverage of the molecules on the at least one portion of the atomically thin material is at least 50% of a maximum coverage of the molecules on the atomically thin material.

25. A method of forming a corrosion protection layer on an atomically thin material that corrodes under normal atmospheric conditions, the method comprising:
exposing at least a portion of the atomically thin material to an alkyl amine; and
forming the coating on the at least a portion of the atomically thin material with the alkyl amine.

26. The method of claim 25, wherein exposing the at least a portion of the atomically thin material to the alkyl amine includes immersing the at least a portion of the atomically thin material in a solution comprising the alkyl amine.

27. The method of claim 25, further comprising maintaining a first temperature of the solution between a freezing temperature and a boiling temperature of the solution.

28. The method of claim 25, wherein the first temperature is closer to the boiling temperature than to the melting temperature of the solution.

29. The method of claim 25, the first temperature is between or equal to 25 degrees Celsius and 300 degrees Celsius.

30. The method of claim 29, further comprising maintaining the first temperature for a time duration between or equal to 1 minute and 60 minutes.

31. The method of claim 25, the method further comprising exposing at least a portion of the coating to an acid to remove the at least a portion of the coating.
